(19) United States
(12) Patent Application Publication
(10) Pub. No.: US 2007/0160856 A1
(43) Pub. Date: Jul. 12, 2007

(54) Polyimide aircraft engine parts

(76) Inventors: Timothy D. Krizan, Wilmington, DE (US); Mark R. Schmeckpeper, Kennett Square, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/633,162

(22) Filed: Dec. 4, 2006

Related U.S. Application Data
(60) Provisional application No. 60/742,248, filed on Dec. 5, 2005.

(51) Int. Cl. B32B 15/04

(52) U.S. Cl. 428/457; 524/447

(57) ABSTRACT

Polyimide compositions containing a lubricious filler and little or no electrically conducting materials are useful for aircraft engine parts, such as bearing, bushings and washers, as well as for other uses. Preferably the polyimides are infusible.

This application claims the benefit of U.S. Provisional Application No. 60/742,248, filed Dec. 5, 2005.

### FIELD OF THE INVENTION

The present invention relates to polyimides compositions comprising a polyimide, a lubricious filler, and optionally other materials, but containing little if any materials which are electrically conductive, are useful as parts in aircraft engines.

### TECHNICAL BACKGROUND

Polyimides, especially polyimides which do not melt (are infusible), are particularly useful in applications in applications where wear and/or low friction and/or low abrasion are important at high temperature and/or where chemicals of various kinds are present. Such applications include aircraft engine parts, aircraft wear pads, automatic transmission bushings and seal rings, tenterframe pads and bushing, material processing equipment parts, and pump bushings and seals. Typically the compositions used contain the polyimide and carbon in some form such as graphite powder and/or carbon fibers. It has been found however, that parts made from such compositions and which are also in contact with metal, and especially if they are exposed to salts (for example from salt water) may accelerate the corrosion of the metal, see for instance U.S. Pat. No. 6,107,990. This patent suggests the use of jet engine bushings which contain a polyimide composition, but have a complex structure and are therefore more expensive to produce. Therefore, there is a need for simpler polyimide parts suitable for the uses described above (for example appropriate wear, friction and/or abrasion properties) and which do not accelerate the corrosion of metals.

U.S. Pat. No. 5,789,523 describes the use of kaolinite as a filler for polyimides. No mention is made of boron nitride as a filler.

U.S. Pat. No. 5,886,129 describes certain polyimide polymers, and certain fillers which may be used with these polyimides. No mention is made of boron nitride. This patent, which is included here by reference, also describes thermally resistant polyimides and methods for testing the thermal stability of polyimides.

### SUMMARY OF THE INVENTION

Briefly stated, and in accordance with one aspect of the present invention, there is provided an aircraft engine, comprising parts comprising a composition, comprising, a polyimide and about 5% to about 70% by weight of a lubricious filler, provided that said composition contains less than 5% by weight of materials which are electrically conducting, and said composition is, in said aircraft engine, in contact with metal, and wherein said percent by weight is based on the total weight of said composition.

Pursuant to another aspect of the present invention, there is provided an aircraft engine part, comprising a composition, comprising, a polyimide and about 5% to about 70% by weight of a lubricious filler, provided that said composition contains less than 5% by weight of materials which are electrically conducting, and said composition is, in said aircraft engine, in contact with metal, and wherein said percent by weight is based on the total weight of said composition.

### DETAILED DESCRIPTION OF THE INVENTION

Herein certain terms are used and they are defined below:

By a “polyimide” is meant a polymer in which at least about 80 percent, more preferably at least about 90%, and especially preferably essentially all of the linking groups between repeat units are imide groups.

By “infusible” herein is meant that the polyimide does not liquefy below the temperature at which it decomposes, i.e., its melting point and/or its glass transition temperature is above its decomposition temperature. Typically parts of such infusible polyimide compositions are formed under heat and pressure, much like powdered metals are formed into parts, see for instance U.S. Pat. No. 4,360,626 which is hereby included by reference.

By “electrically conducting” is meant a material which is commonly thought of as having low electrical resistance (high conductivity). Such materials include carbon (in all forms except diamond), all metals (including other “composite” items such as fibers which are coated with metals), and conductive polymers such as polyanilines, polypyrroles and polythiophenes.

By “in contact with metal” is meant that the item in contact is in contact with metal at least part of the time when the aircraft engine or other apparatus is assembled and in normal use.

When referring to (preferred) compositions herein, these compositions, when appropriate, may also be used in the aircraft engines and other apparatuses and part types described herein. All of the preferred compositional embodiments described below may be combined with any other preferred compositional embodiments to form especially preferred embodiments.

The polyimide contains the characteristic —CO—NR—CO— group as a linear or heterocyclic unit along the main chain of the polymer backbone. The polyimide can be obtained, for example, from the reaction of monomers such as an organic tetracarboxylic acid, or the corresponding anhydride or ester derivative thereof, with an aliphatic or aromatic diamine.

A polyimide precursor as used to prepare a polyimide is an organic polymer that becomes the corresponding polyimide when the polyimide precursor is heated or chemically treated. In certain embodiments of the thus-obtained polyimide, about 60 to 100 mole percent, preferably about 70 mole percent or more, more preferably about 80 mole percent or more, of the repeating units of the polymer chain thereof has a polyimide structure as represented, for example, by the following formula: 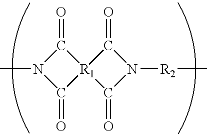
wherein R₁ is a tetravalent aromatic radical having 1 to 5 benzenoid-unsaturated rings of 6 carbon atoms, the four carbonyl groups being directly bonded to different carbon atoms in a benzene ring of the R₁ radical and each pair of carbonyl groups being bonded to adjacent carbon atoms in the benzene ring of the R₁ radical; and R₂ is a divalent aromatic radical having 1 to 5 benzenoid-unsaturated rings of carbon atoms, the two amino groups being directly bonded to different carbon atoms in the benzene ring of the R₂ radical.

Preferred polyimide precursors are aromatic, and provide, when imidized, polyimides in which a benzene ring of an aromatic compound is directly bonded to the imide group. An especially preferred polyimide precursor includes a polyamic acid having a repeating unit represented, for example, by the following general formula, wherein the polyamic acid can be either a homopolymer or copolymer of two or more of the repeating units: 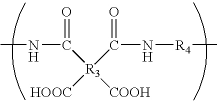
wherein R₃ is a tetravalent aromatic radical having 1 to 5 benzenoid-unsaturated rings of 6 carbon atoms, the four carbonyl groups being directly bonded to different carbon atoms in a benzene ring of the R₃ radical and each pair of carbonyl groups being bonded to adjacent carbon atoms in the benzene ring of the R₃ radical; and R₄ is a divalent aromatic radical having 1 to 5 benzenoid-unsaturated rings of carbon atoms, the two amino groups being directly bonded to different carbon atoms in the benzene ring of the R₄ radical.

Typical examples of a polyamic acid having a repeating unit represented by the general formula above are those obtained from pyromellitic dianhydride (“PMDA”) and diaminodiphenyl ether (“ODA”) and 3,3′,4,4′-biphenyltetracarboxylic dianhydride (“BPDA”) and ODA. When subjected to ring closure, the former becomes poly(4,4′-oxydiphenylenepyromellitimide) and the latter becomes poly(4,4′-oxydiphenylene-3,3′,4,4′-biphenyltetracarboxy imide).

A typical example of a polyimide prepared by a solution imidization process is a rigid, aromatic polyimide composition having the recurring unit: 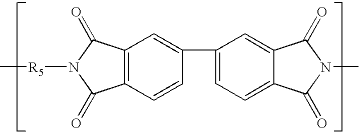
wherein R₅ is greater than 60 to about 85 mole percent p-phenylene diamine (“PPD”) units and about 15 to less than 40 mole percent m-phenylene diamine (“MPD”) units.

The tetracarboxylic acids preferably employed in the practice of the invention, or those from which derivatives useful in the practice of this invention can be prepared, are those having the general formula: 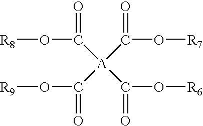
wherein A is a tetravalent organic group and R₆ to R₉, inclusive, comprise hydrogen or a lower alkyl, and preferably methyl, ethyl, or propyl. The tetravalent organic group A preferably has one of the following structures: 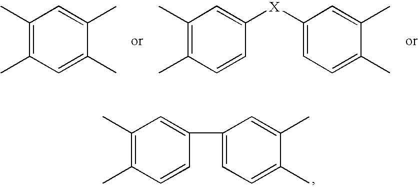
wherein X comprises at least one of 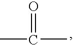
—O—, —S—, —SO₂—, —CH₂—, —CH₂CH₂—, and 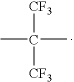
As the aromatic tetracarboxylic acid component, there can be mentioned aromatic tetracarboxylic acids, acid anhydrides thereof, salts thereof and esters thereof. Examples of the aromatic tetracarboxylic acids include 3,3′,4,4′-biphenyltetracarboxylic acid, 2,3,3′,4′-biphenyltetracarboxylic acid, pyromellitic acid, 3,3′,4,4′-benzophenonetetracarboxylic acid, 2,2-bis(3,4-dicarboxyphenyl)propane, bis(3,4-dicarboxyphenyl)methane, bis(3,4-dicarboxyphenyl)ether, bis(3,4-dicarboxyphenyl)thioether, bis(3,4-dicarboxyphenyl)phosphine, 2,2-bis(3′,4′-dicarboxyphenyl)hexafluoropropane, 2,2-bis[4-(3,4-dicarboxyphenoxy)phenyl]propane dianhydride, and bis(3,4-dicarboxyphenyl)sulfone.

These aromatic tetracarboxylic acids can be employed singly or in combination. Preferred is an aromatic tetracarboxylic dianhydride, and particularly preferred are 3,3′,4,4′-biphenyltetracarboxylic dianhydride, pyromellitic dianhydride, 3,3′,4,4′-benzophenonetetracarboxylic dianhydride, and mixtures thereof.

As an organic aromatic diamine, use is preferably made of one or more aromatic and/or heterocyclic diamines, which are themselves known to the art. Such aromatic diamines can be represented by the structure: H₂N—R₁₀—NH₂, wherein R₁₀ is an aromatic group containing up to 16 carbon atoms and, optionally, containing up to one heteroatom in the ring, the heteroatom comprising —N—, —O—, or —S—. Also included herein are those R₁₀ groups wherein R₁₀ is a diphenylene group or a diphenylmethane group. Representative of such diamines are 2,6-diaminopyridine, 3,5-diaminopyridine, m-phenylenediamine, p-phenylene diamine, p,p′-methylene dianiline, 2,6-diaminotoluene, and 2,4-diaminotoluene.

Other examples of the aromatic diamine components, which are merely illustrative, include benzene diamines such as 1,4-diaminobenzene, 1,3-diaminobenzene, and 1,2-diaminobenzene; diphenyl(thio)ether diamines such as 4,4′-diaminodiphenylether, 3,4′-diaminodiphenylether, 3,3′-diaminodiphenylether, and 4,4′-diaminodiphenylthioether; benzophenone diamines such as 3,3′-diaminobenzophenone and 4,4′-diaminobenzophenone; diphenylphosphine diamines such as 3,3′-diaminodiphenylphosphine and 4,4′-diaminodiphenylphosphine; diphenylalkylene diamines such as 3,3′-diaminodiphenylmethane, 4,4′-diaminodiphenylmethane, 3,3′-diaminodiphenylpropane, and 4,4′-diaminodiphenylpropane; diphenylsulfide diamines such as 3,3′-diaminodiphenylsulfide and 4,4′-diaminodiphenylsulfide; diphenylsulfone diamines such as 3,3′-diaminodiphenylsulfone and 4,4′-diaminodiphenylsulfone; and benzidines such as benzidine and 3,3′-dimethylbenzidine.

Other useful diamines have at least one non-heteroatom containing aromatic rings or at least two aromatic rings bridged by a functional group.

These aromatic diamines can be employed singly or in combination. Preferably employed as the aromatic diamine component are 1,4-diaminobenzene, 1,3-diaminobenzene, 4,4′-diaminodiphenylether, and mixtures thereof.

A polyamic acid can be obtained by polymerizing an aromatic diamine component and an aromatic tetracarboxylic acid component preferably in substantially equimolar amounts in an organic polar solvent. The amount of all monomers in the solvent can be in the range of about 5 to about 40 weight percent, more preferably in the range of about 6 to about 35 weight percent, and most preferably in the range of about 8 to about 30 weight percent. The temperature for the reaction generally is not higher than about 100° C., preferably in the range of about 10° C. to 80° C. The time for the polymerization reaction generally is in the range of about 0.2 to 60 hours.

The process by which a polyimide is prepared can also vary according to the identity of the monomers from which the polymer is made up. For example, when an aliphatic diamine and a tetracarboxylic acid are polymerized, the monomers form a complex salt at ambient temperature. Heating of such a reaction mixture at a moderate temperature of about 100 to about 150° C. yields low molecular weight oligomers (for example, a polyamic acid), and these oligomers can, in turn, be transformed into higher molecular weight polymer by further heating at an elevated temperature of about 240 to about 350° C. When a dianhydride is used as a monomer instead of a tetracarboxylic acid, a solvent such as dimethylacetamide or N-methylpyrrolidinone is typically added to the system. An aliphatic diamine and dianhydride also form oligomers at ambient temperature, and subsequent heating at about 150 to about 200° C. drives off the solvent and yields the corresponding polyimide.

As an alternative to the use of an aliphatic diamine and/or an aliphatic diacid or dianhydride, as described above, an aromatic diamine is typically polymerized with a dianhydride in preference to a tetracarboxylic acid, and in such a reaction a catalyst is frequently used in addition to a solvent. A nitrogen-containing base, phenol, or amphoteric material can be used as such a catalyst. Longer periods of heating can be needed to polymerize an aromatic diamine.

The ring closure can also be effected by conventionally used methods such as a heat treatment or a process in which a cyclization agent such as pyridine and acetic anhydride, picoline and acetic anhydride, 2,6-lutidine and acetic anhydride, or the like is used.

Preferred the polyimides used herein are infusible polyimides. In some preferred polyimides essentially all of the connecting groups are imide groups. Preferred polyimides include those made from: a tetracarboxylic anhydride (for example pyromellitic dianhydride and/or 3,3′,4,4′-biphenyltetracarboxylic dianhydride) and about 60 to about 85 mole percent p-phenylenediamine and about 15 to about 40 mole percent m-phenylenediamine (see U.S. Pat. No. 5,886,129, which is hereby included by reference); 3,3′,4,4′-biphenyltetracarboxylic dianhydride and m-phenylenediamine, maleic anhydride and bis(4-aminophenyl)methane; 3,3′,4,4′-benzophenone tetracarboxylic dianhydride, toluenediamine and m-phenylenediamine, 3,3′,4,4′-benzophenone tetracarboxylic dianhydride, bis(4-aminophenyl)methane and nadic anhydride; trimellitic anhydride and m-phenylenediamine; trimellitic anhydride and bis(4-aminophenyl)ether; 3,3′,4,4′-biphenyltetracarboxylic dianhydride and bis(4-aminophenyl)ether; 3,3′,4,4′-biphenyltetracarboxylic dianhydride and m-phenylenediamine; 3,3′,4,4′-biphenyltetracarboxylic dianhydride and p-phenylenediamine; 3,3′,4,4′-benzophenone tetracarboxylic dianhydride and 4,4′-diamonobenzophenone. An especially preferred polyimide is a polyimide made from a tetracarboxylic anhydride (for example pyromellitic dianhydride and/or 3,3′,4,4′-biphenyltetracarboxylic dianhydride) and about 60 to about 85 mole percent p-phenylenediamine and about 15 to about 40 mole percent m-phenylenediamine.

Lubricious fillers are those that reduce friction and/or wear (compared to the polyimide alone) when the polyimide composition is in contact with an moves with respect to another part, usually a metal part. Such fillers are known in the art, and include inorganic materials such as an inorganic, low hardness, thermally stable sheet silicates such as muscovite mica, talc or kaolinite (see U.S. Pat. No. 5,789,523, which is hereby included by reference), and boron nitride, and organic material such as polytetrafluoroethylene or other highly fluorinated thermoplastics. Inorganic lubricious fillers are preferred and boron nitride, sheet silicates such as kaolinite, mica, and talc are preferred inorganic fillers, and sheet silicates are especially preferred, and kaolinite is very preferred. In addition zinc phosphate may be used as an adjuvant in the presence of an inorganic lubricious filler, especially a sheet silicate.

The boron nitride or other lubricious filler used is normally in the form of a fine powder, so it may be readily dispersed in the polyimide powder before part forming, or dispersed in the reaction ingredients when the polyimide polymer is formed. Preferably the minimum amount of boron nitride or other lubricious filler(s) in the composition is about 10 weight percent, more preferably about 15 weight percent. Preferably the maximum amount of boron nitride in the composition is about 50 weight percent, more preferably 40 weight percent. It is to be understood that more than one lubricious filler may be used, and these amounts refer to the total amounts of this type of filler in the composition.

The composition contains less than 5% by weight of materials (total of such materials) which are electrically conducting, preferably less than 2% by weight and especially preferably no materials which are electrically conducting. Generally speaking the less electrically conducting material is present, the less any metal in contact with the composition will tend to be corroded.

Other materials may also be present in the composition. For instance these may be pigments, antioxidants, materials to control the coefficient of thermal expansion, nonlubricious fillers, etc. It should be understood by one of ordinary skill that compositions of the present invention are described herein on a weight percentage basis, wherein the total of all components of the composition total 100 wt %, and wherein the weight percentage of one component in a particular embodiment can be derived by difference knowing the weight percentage of the other components. The polyimide component can, therefore, be present in an amount ranging from about 95 wt % to about 30 wt % of the composition. Within this range, the weight percentage of the polyimide component can vary depending on amount of other materials present in the composition.

Preferably in the aircraft engine or other apparatus in which it is used an item of the composition described herein is in contact with metal at least part of the time when the apparatus is assembled and in normal use. In another preferable situation the apparatus which contains the item may in normal use come into contact with an ionic salt, either deliberately or because the apparatus becomes exposed to the salt. Examples of this include a pump which pumps oil well drilling “mud”, or an aircraft engine which is operated (especially landings an takeoffs) near salt water where salt water spray and/or salt particles may be present (in the air for example).

These compositions may be made, and parts made from them, by techniques normally used for making parts from infusible polymeric materials, namely the application of heat and pressure to powder mixtures of the various ingredients, see for instance U.S. Pat. No. 4,360,626, previously incorporated by reference. These powder mixtures may be made by simple blending of powders, or the inorganic powders may be added to the synthetic process for making the polyimide polymer, thereby obtaining a very intimate mixture of the polymer and other ingredients. If the polyimide is thermoplastic, parts may be formed by melt forming methods, such as extrusion or injection molding, which are typically used to form thermoplastic parts.

These compositions are useful as aircraft engine parts such as bushings, bearings, washers, seal rings, wear pads and slide blocks. All types of aircraft engines are useful such as reciprocating piston engines and jet engines, and jet engines are preferred.

The compositions are useful in other types of apparatuses such as automotive and other types of internal combustion engines, other vehicular subsystems such as exhaust gas recycle systems and clutch systems, pumps, jet engines (not on aircraft), turbochargers, and other aircraft subsystems such as thrust reversers, nacelles, flaps systems, and valves, materials processing equipment such as injection molding machines, material handling equipment conveyors, and tenter frames, where they are useful (depending on the type of apparatus as seals, washers, bearings, bushings, gaskets, wear pads, seal rings, slide blocks and push pins. They are especially useful in uses in which the part made from the composition is exposed to a salt and more especially when exposed to a combination of salt and moisture.

In the Examples, tensile properties are measured using ASTM Method D638. Specific gravity was measured using ASTM Method D792. All test pieces were molded from this resin using a procedure substantially according the procedure described in U.S. Pat. No. 4,360,626 (especially column 2, lines 54-60).

In the Examples the following abbreviations are used:
BPDA—3,3′,4,4′-biphenyltetracarboxylic anhydride
MPD—m-phenylenediamine
PPD—p-phenylenediamine
PMDA—pyromellitic dianhydride
ODA—4,4′-oxydianiline

### EXAMPLE 1

Particles of a polyimide composition containing 40 wt % of a polyimide made from BPDA, PPD, and MPD (with a 70/30 weight ratio of PPD/MPD), 40 wt % titanium dioxide Ti-Pure® R-101 (E.I. DuPont de Nemours & Co., Inc., Wilmington, Del., USA) which is not usually considered a lubricious filler, 5 wt % boron nitride (Polartherm® PT 160 from General Electric Advanced Materials), and 15 wt % kaolinite (Polyfil® DL from Huber Engineered Materials, Atlanta, Ga. 30339, USA) were prepared according to the method described in U.S. Pat. No. 5,886,129 (e.g., Example 7) and milled to pass through a 20 mesh screen. Tensile bars prepared were measured to have a tensile strength of 64.8 MPa, elongation of 0.4%, and a specific gravity of 2.175 g/mL.

### EXAMPLE 2

Particles of a polyimide resin composition containing 80 wt % of a polyimide based on BPDA, PPD, and MPD (with a 70/30 weight ratio of PPD/MPD), 10 wt % boron nitride, and 10 wt % kaolinite were prepared according to the method described in U.S. Pat. No. 5,886,129 (e.g., Example 7) and milled through a 20 mesh screen. Tensile bars prepared were measured to have a tensile strength of 88.9 MPa, elongation of 1.7% and a specific gravity of 1.536 g/mL.

### COMPARATIVE EXAMPLE A

Particles of a polyimide resin composition containing 50 wt % of a polyimide based on BPDA, PPD, and MPD (with a 70/30 weight ratio of PPD/MPD), and 50 wt % synthetic graphite were prepared according to the method described in U.S. Pat. No. 5,886,129 (e.g., Example 7) and milled through a 20 mesh screen.

### COMPARATIVE EXAMPLE B

Particles of a polyimide resin composition containing 90 wt % of a polyimide based on BPDA, PPD, and MPD (with a 70/30 weight ratio of PPD/MPD), and 9 wt % synthetic graphite and 1 wt % kaolinite were prepared according to the method described in U.S. Pat. No. 5,886,129 (e.g., Example 7) and milled through a 20 mesh screen.

### COMPARATIVE EXAMPLE C

Particles of a polyimide resin composition containing 70 wt % of a polyimide based on PMDA and ODA and 30% by weight of a synthetic graphite were prepared according to the procedure described in U.S. Pat. No. 4,755,555 and milled through a 20 mesh screen. Weight loss as measured according to the procedure described in U.S. Pat. No. 5,886,129 (357C., 100 hours, 480 kPa (absolute) was 9.7%.

### EXAMPLE 3

Particles of a polyimide resin composition containing 70 wt % of a polyimide based on BPDA, PPD, and MPD (with a 70/30 weight ratio of PPD/MPD) and 30 wt % boron nitride were prepared according to the method described in U.S. Pat. No. 5,886,129 (e.g., Example 7) and milled through a 20 mesh screen. Tensile bars prepared were measured to have a tensile strength of 12.6 MPa, elongation of 2.4%, and specific gravity of 1.760 g/mL.

### EXAMPLE 4

Particles of a polyimide resin composition containing 70 wt % of a polyimide based on BPDA, PPD, and MPD (with a 70/30 weight ratio of PPD/MPD) and 30 wt % kaolinite were prepared according to the method described in U.S. Pat. No. 5,886,129 (e.g., Example 7) and milled through a 20 mesh screen. Tensile bars prepared were measured to have a tensile strength of 91 MPa, elongation of 1.5%, and specific gravity of 1.617 g/mL.

### EXAMPLE 5

Particles of a polyimide resin composition prepared in example 4 were dry-blended with 10 wt % zinc phosphate powder. Tensile bars prepared were measured to have a tensile strength of 75 MPa and elongation of 1.0%.

### EXAMPLE 6

Bushings were prepared from the resins prepared in Comparative Examples A, B, C and Examples 4 and 5. They were press fit snugly into parts made of Jethete M-152 steel. These assembled specimens were submerged in 5% aqueous sodium chloride solution at room temperature, then suspended in air for 16 hours, and then placed in a 150° C. oven for 8 hours. This procedure was repeated for 10 cycles. The extent of corrosion observed at the interface of bushing and steel is reported in Table 1.

TABLE 1

| Designation | Extent of Corrosion |
|---|---|
| Comparative Example A* | Severe |
| Comparative Example B* | Moderate |
| Comparative Example C* | Severe |
| Example 4 | None |
| Example 5 | None |

*These compositions are representative of commercial jet engine parts.

### EXAMPLE 7

Disks were prepared from the resins prepared in Comparative Example A and Example 3 and each placed into secure contact with a 316 stainless steel coupon. This assembly was then treated for a total of 15 cycles consisting of a 6 h immersion in boiling aqueous 3% NaCl solution followed by an 18 h dry cycle at 80° C. After this time, no corrosion was observed on the surface of the steel coupon in contact with the disk prepared from the resin of Example 3 and substantial corrosion was observed on the surface in contact with the disk prepared from the resin of Comparative Example A.

### EXAMPLE 8

Particles of a polyimide resin composition containing 70 wt % of a polyimide based on PMDA and ODA and 30 wt % kaolinite were prepared according to the method described in U.S. Pat. No. 3,179,614 and milled through a 20 mesh screen. Tensile bars prepared were measured to have a tensile strength of 52.4 MPa, elongation of 1.5% and a specific gravity of 1.570 g/mL. Weight loss as measured according to the procedure described in U.S. Pat. No. 5,886,129 (357C., 100 hours, 480 kPa (absolute) was 5.7%.

It is therefore, apparent that there has been provided in accordance with the present invention, polyimide aircraft engine parts that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. An aircraft engine part comprising: a polyimide and about 5% to about 70% by weight of a lubricious filler, provided that said composition contains less than 5% by weight of materials which are electrically conducting, and also provided that said composition is in contact with metal when used as part of an airplane engine, and wherein said percent by weight is based on the total weight of said composition.

2. The aircraft engine part as recited in claim 1 wherein said lubricious filler is selected from the group consisting of boron nitride, kaolinite, mica or talc.

3. The aircraft engine part as recited in claim 1 wherein said lubricious filler is a sheet silicate.

4. The aircraft engine part as recited in claim 3 wherein said sheet silicate is kaolinite.

5. The aircraft engine part of claim 3 wherein zinc phosphate is also present in said composition.

6. The aircraft engine part as recited in claim 3 wherein said lubricious filler is present in an amount of from about 15% to about 40% by weight.

7. The aircraft engine part as recited in claim 1 wherein said polyimide is infusible.

8. The aircraft engine part as recited in claim 6 wherein said polyimide is infusible.

9. The aircraft engine part as recited in claim 1 wherein said polyimide is derived from:
a tetracarboxylic anhydride and about 60 to about 85 mole percent p-phenylenediamine and about 15 to about 40 mole percent m-phenylenediamine, or 3,3′,4,4′-biphenyltetracarboxylic dianhydride and m-phenylenediamine, maleic anhydride and bis(4-aminophenyl)methane, or 3,3′,4,4′-benzophenone tetracarboxylic dianhydride, toluenediamine and m-phenylenediamine, or 3,3′,4,4′-benzophenone tetracarboxylic dianhydride, bis(4-aminophenyl)methane and nadic anhydride, or trimellitic anhydride and m-phenylenediamine, or trimellitic anhydride and bis(4-aminophenyl)ether, or 3,3′,4,4′-biphenyltetracarboxylic dianhydride and bis(4-aminophenyl)ether; 3,3′,4,4′-biphenyltetracarboxylic dianhydride and m-phenylenediamine, or 3,3′,4,4′-biphenyltetracarboxylic dianhydride and p-phenylenediamine, or 3,3′,4,4′-benzophenone tetracarboxylic dianhydride and 4,4′-diaminobenzophenone.

10. The aircraft engine part as recited in claim 1 wherein said polyimide is derived from a tetracarboxylic anhydride and about 60 to about 85 mole percent p-phenylenediamine and about 15 to about 40 mole percent m-phenylenediamine.

11. An aircraft engine comprising a part as recited in claim 1.
